(19) United States
(12) Patent Application Publication
(10) Pub. No.: US 2026/0104309 A1
(43) Pub. Date: Apr. 16, 2026

(54) METHOD AND SYSTEM FOR EVALUATING TUNNEL HEALTH BASED ON MACHINE LEARNING

(71) Applicant: SHANDONG UNIVERSITY, Jinan (CN)

(72) Inventors: Jinglong LI, Jinan (CN); Diyang CHEN, Jinan (CN); Xiufang ZHENG, Jinan (CN); Yupeng CUI, Jinan (CN); Fengling ZHANG, Jinan (CN); Min TANG, Jinan (CN); Chenxu YAN, Jinan (CN); Chang SU, Jinan (CN)

(21) Appl. No.: 19/343,008

(22) Filed: Sep. 29, 2025

(30) Foreign Application Priority Data
Oct. 10, 2024 (CN) 2024114108299

(51) Int. Cl. G01M 5/00; G01M 3/00; G06T 7/00

(52) U.S. Cl. CPC G01M 5/0033; G01M 3/007; G06T 7/0004

(57) ABSTRACT

A method for evaluating tunnel health based on machine learning, including: constructing a tunnel health evaluation layer structure model; acquiring criterion layer data based on current index layer data of each section of a tunnel; calculating a lining deformation superposition quantity according to the data of lining cracks and the data of water seepage and leakage, and correcting the data of lining deformation based on the superposition quantity to obtain real data of lining deformation; and inputting the real data of lining deformation and other current tunnel criterion layer data into a machine learning model to obtain a current health level judging result of each section of the tunnel, implementing corresponding tunnel renovation measures according to the health level judging result of each section of the tunnel.

### CROSS-REFERENCE TO RELATED APPLICATIONS

The present disclosure claims the priority of the Chinese Patent Application No. 202411410829.9 filed with the China National Intellectual Property Administration on Oct. 10, 2024, and entitled “Method and System for Evaluating Tunnel Health Based on Machine Learning”, which is incorporated herein by reference in its entirety and constitutes a part of the present disclosure for all purposes.

### TECHNICAL FIELD

The present disclosure relates to the technical field of tunnel health evaluation, and particularly relates to a method and system for evaluating tunnel health based on machine learning.

### BACKGROUND

With the rapid development of transportation infrastructure, the quantity and the operation time of tunnels have also increased. At the same time, many operating tunnels have suffered from various types of diseases such as lining cracks, water seepage and leakage, lining back cavities, and lining deformation. Development of these diseases may destroy the integrity of tunnel structures, and may also threaten the safety of vehicles and personnel. Through performing of health evaluation on the tunnel, the traffic safety may be ensured, and the service life of the tunnel may be prolonged. A conventional method for evaluating tunnel health relies on regular manual inspection, which is time-consuming and labor-intensive, and the development of tunnel diseases is difficult to predict.

A machine learning model may comprehensively consider various factors affecting tunnel health, and by training a model, a complex non-linear relationship between a disease index and a health level is captured to predict the health state of the tunnel, so that the health evaluation accuracy and efficiency of the tunnel are improved.

The inventor discovers that in the related art, a relationship between each of disease indexes and the health condition of the tunnel is mostly considered independently, but the lining cracks and the water seepage and leakage are mutually associated and affect each other instead of existing in an isolated manner: the lining cracks and the water seepage and leakage are two common diseases in the tunnel, the lining cracks provide passages for water, so that the water seepage and leakage is easier to occur; and the water seepage and leakage may further accelerate the lining corrosion and deterioration and promote the crack extension and increase. Such a superposition condition may obviously aggravate the damage to the tunnel structure, shorten the service life of the tunnel, and reduce the safety. Therefore, how to determine whether a superposition effect of lining cracks and water seepage and leakage may be generated or not and considering the superposition effect during tunnel health evaluation to improve the evaluation accuracy are problems to be urgently resolved.

### SUMMARY

In order to solve the above problems, the present disclosure provides a method and system for evaluating tunnel health based on machine learning. Through preferential judging of whether a superposition effect is generated or not and considering of the superposition effect between the water seepage and leakage and lining cracks, tunnel renovation measures corresponding to each level are determined and implemented based on a health level judging result of each section of the tunnel, so that the health evaluation accuracy of the tunnel is improved.

In order to achieve the above objectives, the present disclosure adopts the following technical solution:

In a first aspect, the present disclosure provides a method for evaluating tunnel health based on machine learning, including:
constructing a tunnel health evaluation layer structure model, and defining an index layer, a criterion layer and a target layer;
collecting current index layer data of each section of a tunnel, and acquiring criterion layer data according to the index layer data, the criterion layer data including data of lining cracks, data of water seepage and leakage, data of lining material deterioration, data of lining back cavities, data of lining peeling, and data of lining deformation;
calculating a lining deformation superposition quantity according to the data of lining cracks and the data of water seepage and leakage, and correcting the data of lining deformation based on the lining deformation superposition quantity to obtain real data of lining deformation;
inputting the real data of lining deformation and other current tunnel criterion layer data into a trained machine learning model to obtain a health level determination result of each section of the tunnel, where the machine learning model is constructed based on the criterion layer data and a target layer level, the machine learning model is trained by using historical tunnel criterion layer data and a corresponding health level, and the target layer level includes four health levels; and
determining and implementing tunnel renovation measures corresponding to each level according to the health level judging result of each section of the tunnel.

Preferably, the index layer data corresponding to each criterion layer includes:
the data of lining cracks, including data of a crack length, data of a crack width and data of a crack depth;
the data of water seepage and leakage, including data of a water seepage and leakage state, data of a pH value and data of a freezing damage state;
the data of lining material deterioration, including data of a lining strength, data of a lining thickness and data of reinforcement corrosion;
the data of lining back cavities, including data of a cavity depth;
the data of lining peeling, including data of a falling possibility, data of a peeling depth, and data of a peeling diameter; and
the data of lining deformation, including data of a deformation amount and data of a deformation speed.

Preferably, the collecting current index layer data of each section of a tunnel, and acquiring criterion layer data according to the index layer data specifically includes:
according to an important influence relationship among all feature parameters of each layer, selecting a corresponding exponential scale, building a judging matrix between the index layer and the criterion layer, and calculating a weight value between the index layer and the criterion layer in the judging matrix if the consistency of the judging matrix is smaller than a set value; and
calculating the criterion layer data according to the index layer data and the weight value.

Preferably, before the calculating a lining deformation superposition quantity according to the data of lining cracks and the data of water seepage and leakage, judging whether a superposition effect of lining cracks and water seepage and leakage is generated or not is included:
acquiring an image of the lining cracks and the water seepage and leakage, recognizing contours of the lining cracks and the water seepage and leakage, and building detection frames based on the contours; and
acquiring middle points of the detection frames, and judging that the superposition effect of the lining cracks and the water seepage and leakage in the detection frames is generated if the distance between middle points of the adjacent detection frames of the lining cracks and the water seepage and leakage is smaller than a preset length.

Preferably, the calculating a lining deformation superposition quantity according to the data of lining cracks and the data of water seepage and leakage specifically includes:
inputting the current data of lining cracks and data of water seepage and leakage into a linear regression model to obtain the lining deformation superposition quantity.

The linear regression model has a training process of training the linear regression model by using the data of lining cracks and the data of water seepage and leakage at a first moment, and the data of lining cracks and the data of water seepage and leakage at a second moment of a historical time period as input values, and using a lining deformation amount in a corresponding time period as an output value until a model loss function is minimum.

Preferably, the correcting the data of lining deformation based on the lining deformation superposition quantity to obtain real data of lining deformation specifically includes:
respectively setting weights for the data of lining deformation and the lining deformation superposition quantity; and
respectively multiplying the data of lining deformation and the lining deformation superposition quantity by corresponding weights, and then adding acquired values to obtain the real data of lining deformation.

Preferably, the machine learning model includes a random forest, an extreme Gradient Boosting (XGBOOST), a decision tree, and a support vector machine.

Preferably, the determining and implementing tunnel renovation measures corresponding to each level specifically includes:

determining and implementing tunnel renovation measures corresponding to each level according to the health level judging result of each section of the tunnel to realize renovation for different levels, and completing renovation mode selection and execution priority setting based on a preset rule.

In a second aspect, the present disclosure provides a system for evaluating tunnel health based on machine learning, including:
a layer model construction module, configured to construct a tunnel health evaluation layer structure model, and define an index layer, a criterion layer and a target layer;
a criterion layer data acquiring module, configured to collect current index layer data of each section of a tunnel, and acquire criterion layer data according to the index layer data, the criterion layer data including data of lining cracks, data of water seepage and leakage, data of lining material deterioration, data of lining back cavities, data of lining peeling, and data of lining deformation;
a deformation data correction module, configured to calculate a lining deformation superposition quantity according to the data of lining cracks and the data of water seepage and leakage, and correct the data of lining deformation based on the lining deformation superposition quantity to obtain real data of lining deformation;
a health evaluation module, configured to input the real data of lining deformation and other current tunnel criterion layer data into a trained machine learning model to obtain a current health level determination result of each section of the tunnel, where the machine learning model is constructed based on the criterion layer data and a target layer level, the machine learning model is trained by using historical tunnel criterion layer data and a corresponding health level, and the target layer level includes four health levels; and
a renovation decision module, configured to determine and implement tunnel renovation measures corresponding to each level according to the health level judging result of each section of the tunnel to realize renovation for different levels, and complete renovation mode selection and execution priority setting based on a preset rule.

In a third aspect, the present disclosure provides a non-transitory computer-readable storage medium, having a computer program stored therein, and the program implements the steps of the method for evaluating tunnel health based on machine learning in the first aspect when being executed by a processor.

In a fourth aspect, the present disclosure provides a computer device, including a memory, a processor, and a computer program stored on the memory and capable of running on the processor, and the processor implements the steps of the method for evaluating tunnel health based on machine learning in the first aspect when executing the program.

Compared with the related art, the present disclosure has the following beneficial effects:

In the present disclosure, it has been considered that the lining cracks and the water seepage and leakage in the tunnel are generally not isolated diseases, and they may have interaction. Therefore, the superposition effect is considered during the health evaluation on the tunnel based on the collected disease feature data, whether the superposition effect is generated or not is judged before considering the superposition effect, the real health condition of the tunnel may be more accurately reflected, and one-sidedness possibly caused by single-factor evaluation is avoided.

The advantages in additional aspects of the present disclosure will be set forth in part in the description below, parts of which will become apparent from the description below, or will be understood by the practice of the present disclosure.

### BRIEF DESCRIPTION OF THE DRAWINGS

The accompanying drawings constituting a part of the present disclosure are used to provide a further understanding of the present disclosure. The schematic embodiments of the present disclosure and descriptions thereof are used to explain the present disclosure, and do not constitute an improper limitation of the present disclosure.

FIG. 1 is a main flowchart of a method for evaluating tunnel health based on machine learning provided by the present disclosure;

FIG. 2 is a health evaluation index system provided by the present disclosure; and

FIG. 3 is a 10-fold cross-validation iteration diagram of a machine learning model provided by the present disclosure.

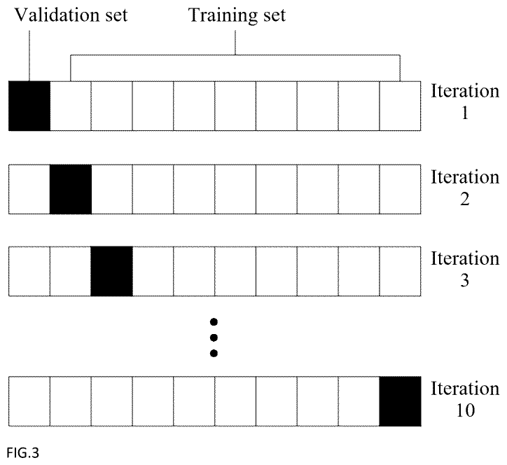

### DETAILED DESCRIPTION

The present disclosure will be further illustrated hereafter in combination with accompanying drawings and embodiments.

### Example 1

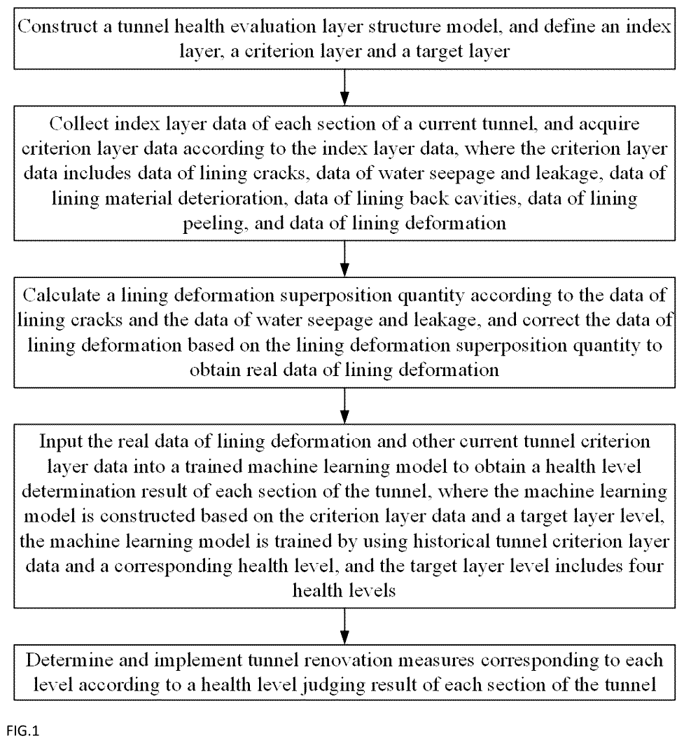

As shown in FIG. 1, the present example discloses a method for evaluating tunnel health based on machine learning, including:

S1: constructing a tunnel health evaluation layer structure model, and defining an index layer, a criterion layer, and a target layer.

S2: collecting current index layer data of each section of a tunnel, and acquiring criterion layer data according to the index layer data. The criterion layer data includes data of lining cracks, data of water seepage and leakage, data of lining material deterioration, data of lining back cavities, data of lining peeling, and data of lining deformation.

S3: calculating a lining deformation superposition quantity according to the data of lining cracks and the data of water seepage and leakage, and correcting the data of lining deformation based on the lining deformation superposition quantity to obtain real data of lining deformation.

S4: inputting the real data of lining deformation and other current tunnel criterion layer data into the trained machine learning model to obtain a current health level determination result of each section of the tunnel. The machine learning model is constructed based on the criterion layer data and a target layer level, the machine learning model is trained by using historical tunnel criterion layer data and a corresponding health level, and the target layer level includes four health levels.

S5: determining and implementing tunnel renovation measures corresponding to each level according to the health level judging result of each section of the tunnel.

Specifically, the tunnel health evaluation layer structure model is constructed at first, and the index layer, the criterion layer and the target layer are defined.

During construction of a highway tunnel health state index system, key indexes influencing the health state of the tunnel are determined by following principles of scientificity, integrity, simplicity, independence, layering and operability.

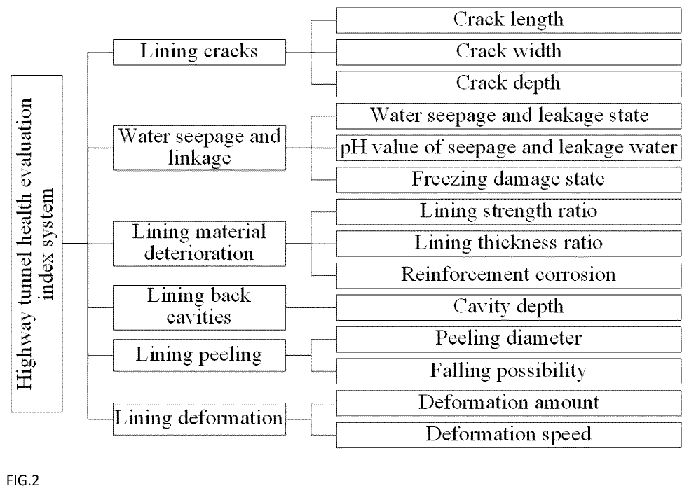

A health evaluation index system for an operating highway tunnel as shown in FIG. 2 is built, and a highway tunnel health evaluation index system is divided into three layers by a layering analysis method.

The first layer is a target layer, including a target object, i.e., a highway tunnel health state, expressed by a health level. During construction of the highway tunnel health level, according to relevant specifications at home and abroad, a four-level division method is adopted for dividing the health condition of the tunnel structure into a level 1 (no disease or light disease), a level 2 (general disease), a level 3 (serious disease), and a level 4 (very serious disease), and there is a clear boundary between every two levels.

The second layer is a criterion layer, composed of factors influencing the health state of the highway tunnel, 6 aspects including lining cracks, water seepage and leakage, lining material deterioration, lining back cavities, lining peeling, and lining deformation.

The third layer is an index layer, composed of each index influencing the factors of the criterion layer, and the data of the lining cracks includes 3 indexes: a length, a width, and a depth of cracks; the data of water seepage and leakage includes 3 indexes: a water seepage and leakage state, a pH value, and a freezing damage state; the data of lining material deterioration includes 3 indexes: a lining strength ratio, a lining thickness ratio, and reinforcement corrosion; the data of lining back cavities includes 1 index: a cavity depth; the data of lining peeling includes 3 indexes: a falling possibility, a depth, and a diameter; and the data of lining deformation includes 2 indexes: a deformation amount and a deformation speed.

For a tunnel disease original data set obtained through field detection, data outliers are detected and removed by using a box plots method, missing values are filled by using an interpolation method, the data is standardized by using a Z-score method, a standardized evaluation data set is formed, and a data foundation is provided for the model training. At the same time, based on a standardized data set, correlation analysis between different feature indexes is performed by using a Karl Pearson correlation coefficient calculation formula. A Pearson correlation coefficient calculation formula is:

$$γ = \frac{\sum ( {x}_{i} - \overline{x} ) ( {y}_{i} - \overline{y} )}{\sqrt{\sum {( {x}_{i} - \overline{x} )}^{2}} \cdot \sqrt{\sum {( {y}_{i} - \overline{y} )}^{2}}} ,$$

wherein, x and y are observed values of two variables, and x and y are mean values of the variables x and y.

Generally, absolute values of correlation coefficients fall within ranges of 0.0 to 0.2, 0.2 to 0.4, 0.4 to 0.6, 0.6 to 0.8, and 0.8 to 1.0. Correlations between different feature indexes are respectively “extremely weak correlation or no correlation”, “weak correlation”, “intermediate correlation”, “strong correlation”, and “extremely strong correlation”. The absolute value of the correlation coefficient being closer to 1 indicates a stronger correlation. The correlation coefficient between different indexes is calculated, a correlation coefficient thermal matrix is built, and the reasonableness of highway tunnel health evaluation index selection is verified.

The processed data is stored into a database, data calling and further processing are performed by using Python, and the integrity and availability of the data set are ensured.

As a further implementation, through considering of the lining cracks and the water seepage and leakage as two major diseases influencing the health of the tunnel, the lining corrosion may be obviously aggravated under the superimposition condition of the lining cracks and the water seepage and leakage, and more serious influence may be caused on the integral health of the tunnel. Therefore, the present example considers the superimposition effect of the lining cracks and the water seepage and leakage.

If a distance from the lining cracks to a water seepage and leakage region is long, there will be no interaction possibility. Therefore, before the calculation of the superimposition effect, whether the superimposition effect is generated or not is firstly confirmed. Specific steps are as follows:

S301: acquiring an image of the lining cracks and the water seepage and leakage, recognizing contours of the lining cracks and the water seepage and leakage, and building detection frames based on the contours.

S302: acquiring middle points of the detection frames, and if the distance between middle points of the adjacent detection frames of the lining cracks and the water seepage and leakage is smaller than a preset length, judging that the superposition effect of the lining cracks and the water seepage and leakage in the detection frames is generated.

After the occurrence of the superimposition effect is determined, the lining deformation amount generated by the lining cracks and the water seepage and leakage due to the superimposition effect is calculated. The specific steps are as follows:

S311: inputting the current data of lining cracks and data of water seepage and leakage into a linear regression model to obtain the lining deformation superposition quantity.

The linear regression model has a training process of training the linear regression model by using the data of lining cracks and the data of water seepage and leakage at a first moment, and the data of lining cracks and the data of water seepage and leakage at a second moment of a historical time period as input values, and using a lining deformation amount in a corresponding time period as an output value until a model loss function is minimum.

After the lining deformation superposition quantity is obtained, the initial data of lining deformation is corrected. The specific steps are as follows:

S321: respectively setting weights for the data of lining deformation and the lining deformation superposition quantity.

S322: respectively multiplying the data of lining deformation and the lining deformation superposition quantity by corresponding weights, and then adding acquired values to obtain the real data of lining deformation.

In S4, the current health level judging result of the tunnel is obtained based on machine learning.

In a Python environment, random forest, XGBOOST, decision tree, and support vector machine algorithms are implemented by using a Scikit-learn library.

Firstly, stratified sampling is performed according to a proportion of 7:3, and the data set is divided into a training set and a test set. The training set is used for fitting the model, and adjusting model parameters. The test set is used for evaluating a final model.

The hyper-parameter selection is performed by combining manual parameter adjustment with a grid searching method. For the manual parameter adjustment, firstly, parameters with great influence on the model performance are determined, then, the refining is performed on the basis of these parameters through grid searching, and an optimum hyper-parameter combination is selected through 10-fold cross-validation. The transversal of grid searching and evaluation of cross-validation are favorable for finding the model configuration capable of best representing the data features, so that the prediction precision and generalization ability of the model are improved.

The model evaluation is performed by using a 10-fold cross-validation mode, and the performance of the model in practical application is accurately estimated. Firstly, the training set is divided into 10 mutual exclusion subsets with similar sizes and similar distributions, and then, cycling is performed for 10 times. In each time, 9 subsets are merged into a new training set, and the rest 1 subset is used as a validation set. In each cycle, the training set is used for training the model, and the performance of the model is evaluated by using the validation set. Finally, mean values of the 10 times of training and validation results are taken to be used as the practical performance of the model.

Hyper-parameter optimization of the machine learning model is performed based on the combination of manual parameter adjustment and the grid searching method. Before grid searching parameter adjustment, a hyper-parameter with the great influence on the model performance is possibly determined through manual parameter adjustment, and the computation amount in the grid searching process is then reduced. During grid searching, the performance of each hyper-performance combination is evaluated through 10-fold cross-validation, and the overfitting risk is favorably reduced. Through the transversal of the grid searching and the evaluation of the cross-validation, the optimum hyper-parameter combination is finally selected, and the model performance maximization is ensured.

After the optimum hyper-parameter combination is determined, the performance of the machine learning model is validated on the test set, and the machine learning model is finally evaluated by using 4 evaluation indexes: accuracy, precision, recall, and F1-score. A calculation method of the evaluation indexes is as follows:

### 1. Accuracy

Accuracy refers to a proportion of the quantity of correctly predicted samples to the quantity of all samples.

$$A C C = \frac{T P + T N}{T P + F P + T N + F N} .$$

### 2. Precision

Precision refers to a proportion of actually positive samples to samples predicted as positive samples.

$$P = \frac{T P}{T P + F P} .$$

### 3. Recall

Recall refers to a proportion of samples correctly predicted as positive samples to actually positive samples.

$$R = \frac{T P}{T P + F N} .$$

4. F1-score

F1-score refers to a harmonic mean of precision and recall.

$$F 1 = \frac{2 * P * R}{P + R} .$$

In the formulas, TP represents positive samples predicted to be positive by the model; FP represents negative samples predicted to be positive by the model; TN represents negative samples predicted to be negative by the model; and FN represents positive samples predicted to be negative by the model.

Based on the above model evaluation result, the machine learning model with the best performance in aspects including generalization ability and prediction accuracy is selected. After the newly collected tunnel data is inputted into the model, the model may use the learned rule and mode to predict the health level of each section of the tunnel according to the inputted feature data. Compared with a conventional method for evaluating tunnel health, the present disclosure may realize the higher evaluation accuracy and efficiency, the tiny change of the tunnel health condition may be timely captured, and the tunnel disease development may be effectively predicted and managed, so that the operation safety and the maintenance efficiency of the tunnel are greatly improved.

In S5, tunnel renovation measures corresponding to each level are determined and implemented according to the health level judging result of each section of the tunnel.

The tunnel renovation measures corresponding to each level are determined and implemented according to the health level judging result of each section of the tunnel to realize renovation for different levels, and renovation mode selection and execution priority setting are completed based on a preset rule.

For a Level 1 (no disease or light disease) section, a selected renovation mode is regular inspection and continuous monitoring, and the execution priority is the lowest.

For a Level 2 (general disease) section, a selected renovation mode is local restoration and intensive monitoring enhancement and the execution priority is moderate.

For a Level 3 (serious disease) section, a selected renovation mode is local reinforcement and intensive treatment, and the execution priority is high.

For a Level 4 (very serious disease) section, a selected renovation mode is immediate out of operation, comprehensive reinforcement or reconstruction, and the execution priority is the highest.

The present specific embodiment aims at improving the tunnel health state evaluation accuracy and efficiency, and realizing the early prediction and precise treatment on the tunnel disease development at the same time. Firstly, a highway tunnel health evaluation index system covering the target layer, the criterion layer and the index layer is built, and various aspects including lining cracks, water seepage and leakage, lining material deterioration, lining back cavities, lining peeling, and lining deformation moving sedimentation are considered in detail. The health condition of the tunnel structure is classified according to a four-level division method, and the boundary between two levels is clearly defined. Based on the above, the tunnel disease data is obtained through field detection, and the standardized evaluation data set is formed through preprocessing. The data set is trained through machine learning algorithms such as random forest and XGBOOST, the optimum model parameter is selected, iteration and optimization are continuously performed, and the machine learning model for predicting the tunnel health level is built. Then, the model is subjected to comprehensive evaluation by validating the model performance on the test set, so as to ensure the high accuracy and reliability of the prediction. Finally, tunnel renovation measures corresponding to each level are determined and implemented according to the health level judging result of each section of the tunnel. The present disclosure improves the scientificity and accuracy of the highway tunnel health evaluation and disease prediction, is favorably for optimizing the tunnel maintenance resource allocation, and improves the tunnel operation management level.

### Example 2

The present example provides a system for evaluating tunnel health based on machine learning, including:
a layer model construction module, configured to construct a tunnel health evaluation layer structure model, and define an index layer, a criterion layer and a target layer;
a criterion layer data acquiring module, configured to collect current index layer data of each section of a tunnel, and acquire criterion layer data according to the index layer data, the criterion layer data including data of lining cracks, data of water seepage and leakage, data of lining material deterioration, data of lining back cavities, data of lining peeling, and data of lining deformation;
a deformation data correction module, configured to calculate a lining deformation superposition quantity according to the data of lining cracks and the data of water seepage and leakage, and correct the data of lining deformation based on the lining deformation superposition quantity to obtain real data of lining deformation;
a health evaluation module, configured to input the real data of lining deformation and other current tunnel criterion layer data into a trained machine learning model to obtain a current health level determination result of each section of the tunnel, where the machine learning model is constructed based on the criterion layer data and a target layer level, the machine learning model is trained by using historical tunnel criterion layer data and a corresponding health level, and the target layer level includes four health levels; and
a renovation decision module, configured to determine and implement tunnel renovation measures corresponding to each level according to the health level judging result of each section of the tunnel to realize renovation for different levels, and complete renovation mode selection and execution priority setting based on a preset rule.

### Example 3

The present example provides a computer-readable storage medium, having a computer program stored therein, and the program implements the steps of the method for evaluating tunnel health based on machine learning in Embodiment I when being executed by a processor.

### Example 4

The present example provides a computer device, including a memory, a processor, and a computer program stored on the memory and capable of running on the processor, and the processor implements the steps of the method for evaluating tunnel health based on machine learning in Embodiment I when executing the program.

Each step or module involved in Embodiment II to Embodiment IV corresponds to that in Embodiment I, and references may be taken to relevant descriptions in Embodiment I for the specific implementations. The term “computer-readable storage medium” should be understood as a single medium or multiple media including one or more instruction sets, and should be also be understood to include any medium capable of storing, encoding or carrying instruction sets executed by a processor and enabling the processor to perform any one method of the present disclosure.

The foregoing descriptions are merely exemplary embodiments of the present disclosure, but are not intended to limit the present disclosure. A person skilled in the art may make various alterations and variations to the present disclosure. Any modification, equivalent replacement, or improvement and the like made within the spirit and principle of the present disclosure shall fall within the protection scope of the present disclosure.

1. A method for evaluating tunnel health based on machine learning, comprising:
constructing a tunnel health evaluation layer structure model, and defining an index layer, a criterion layer and a target layer;
collecting current index layer data of a tunnel, and acquiring criterion layer data according to the index layer data, the criterion layer data comprising data of lining cracks, data of water seepage and leakage, data of lining material deterioration, data of lining back cavities, data of lining peeling, and data of lining deformation;
calculating a lining deformation superposition quantity according to the data of lining cracks and the data of water seepage and leakage, and correcting the data of lining deformation based on the lining deformation superposition quantity to obtain real data of lining deformation; and
before the calculating a lining deformation superposition quantity according to the data of lining cracks and the data of water seepage and leakage, judging whether a superposition effect of lining cracks and water seepage and leakage is generated or not: acquiring an image of the lining cracks and the water seepage and leakage, recognizing contours of the lining cracks and the water seepage and leakage, and building detection frames based on the contours; acquiring middle points of the detection frames, and judging that the superposition effect of the lining cracks and the water seepage and leakage in the detection frames is generated if the distance between middle points of the adjacent detection frames of the lining cracks and the water seepage and leakage is smaller than a preset length, the calculating a lining deformation superposition quantity according to the data of lining cracks and the data of water seepage and leakage specifically comprising: inputting the current data of lining cracks and data of water seepage and leakage into a linear regression model to obtain the lining deformation superposition quantity, the linear regression model having a training process of training the linear regression model by using the data of lining cracks and the data of water seepage and leakage at a first moment, and the data of lining cracks and the data of water seepage and leakage at a second moment of a historical time period as input values, and using a lining deformation amount in a corresponding time period as an output value until a model loss function is minimum; and
inputting the real data of lining deformation and other current tunnel criterion layer data into a trained machine learning model to obtain a current health evaluation result of the tunnel, wherein
the machine learning model is constructed based on the criterion layer data and a target layer level, and the machine learning model is trained by using historical tunnel criterion layer data and a corresponding health level; and the target layer level comprises four health levels.

2. The method for evaluating tunnel health based on machine learning according to claim 1, wherein the index layer data corresponding to the criterion layer comprises:
the data of lining cracks, comprising data of a crack length, data of a crack width, and data of a crack depth;
the data of water seepage and leakage, comprising data of a water seepage and leakage state, data of a pH value and data of a freezing damage state;
the data of lining material deterioration, comprising data of a lining strength, data of a lining thickness and data of reinforcement corrosion;
the data of lining back cavities, comprising data of a cavity depth;
the data of lining peeling, comprising data of a falling possibility, data of a peeling depth, and data of a peeling diameter; and
the data of lining deformation, comprising data of a deformation amount and data of a deformation speed.

3. The method for evaluating tunnel health based on machine learning according to claim 1, wherein the collecting current index layer data of a tunnel, and acquiring criterion layer data according to the index layer data specifically comprises:
according to an important influence relationship among all feature parameters of each layer, selecting a corresponding exponential scale, building a judging matrix between the index layer and the criterion layer, and calculating a weight value between the index layer and the criterion layer in the judging matrix if the consistency of the judging matrix is smaller than a set value; and
calculating the criterion layer data according to the index layer data and the weight value.

4. The method for evaluating tunnel health based on machine learning according to claim 1, wherein the correcting the data of lining deformation based on the lining deformation superposition quantity to obtain real data of lining deformation specifically comprises:
respectively setting weights for the data of lining deformation and the lining deformation superposition quantity; and
respectively multiplying the data of lining deformation and the lining deformation superposition quantity by corresponding weights, and then adding acquired values to obtain the real data of lining deformation.

5. The method for evaluating tunnel health based on machine learning according to claim 1, wherein the machine learning model comprises a random forest, an XGBOOST, a decision tree, a support vector machine, and a neural network.

6. A system for evaluating tunnel health based on machine learning, comprising:
a layer model construction module, configured to construct a tunnel health evaluation layer structure model, and define an index layer, a criterion layer and a target layer;
a criterion layer data acquiring module, configured to collect current index layer data of a tunnel, and acquire criterion layer data according to the index layer data, the criterion layer data comprising data of lining cracks, data of water seepage and leakage, data of lining material deterioration, data of lining back cavities, data of lining peeling, and data of lining deformation;
a deformation data correction module, configured to calculate a lining deformation superposition quantity according to the data of lining cracks and the data of water seepage and leakage, and correct the data of lining deformation based on the lining deformation superposition quantity to obtain real data of lining deformation; and before the calculating a lining deformation superposition quantity according to the data of lining cracks and the data of water seepage and leakage, judge whether a superposition effect of lining cracks and water seepage and leakage is generated or not: acquiring an image of the lining cracks and the water seepage and leakage, recognizing contours of the lining cracks and the water seepage and leakage, and building detection frames based on the contours; acquiring middle points of the detection frames, and judging that the superposition effect of the lining cracks and the water seepage and leakage in the detection frames is generated if the distance between middle points of the adjacent detection frames of the lining cracks and the water seepage and leakage is smaller than a preset length, the calculating a lining deformation superposition quantity according to the data of lining cracks and the data of water seepage and leakage specifically comprising: inputting the current data of lining cracks and data of water seepage and leakage into a linear regression model to obtain the lining deformation superposition quantity, the linear regression model having a training process of training the linear regression model by using the data of lining cracks and the data of water seepage and leakage at a first moment, and the data of lining cracks and the data of water seepage and leakage at a second moment of a historical time period as input values, and using a lining deformation amount in a corresponding time period as an output value until a model loss function is minimum; and
a health evaluation module, configured to input the real data of lining deformation and other current tunnel criterion layer data into a trained machine learning model to obtain the current health evaluation result of the tunnel, wherein the machine learning model is constructed based on the criterion layer data and a target layer level, the machine learning model is trained by using historical tunnel criterion layer data and a corresponding health level, and the target layer level comprises four health levels.

7. A computer-readable storage medium, having a computer program stored therein, the program implementing the steps of the method for evaluating tunnel health based on machine learning according to claim 1 when being executed by a processor.

8. A computer device, comprising a memory, a processor, and a computer program stored on the memory and capable of running on the processor, the processor implementing the steps of the method for evaluating tunnel health based on machine learning according to claim 1 when executing the program.
